(19) United States
(12) Patent Application Publication
(10) Pub. No.: US 2010/0049567 A1
(43) Pub. Date: Feb. 25, 2010

(54) SYSTEM AND METHOD FOR INTEGRATED ADVERTISEMENT MANAGEMENT

(76) Inventors: Gulrukh Ahanger, Brookline, MA (US); Timothy Avila, San Francisco, CA (US); Todd Boes, Marblehead, MA (US); Pavel Murnikov, Cambridge, MA (US)

Correspondence Address: YAHOO! INC. C/O GREENBERG TRAURIG, LLP, MET LIFE BUILDING, 200 PARK AVENUE, NEW YORK, NY, 10166, US

(21) Appl. No.: 12/195,219

(22) Filed: Aug. 20, 2008

(51) Int. Cl. G06Q 30/00; G06Q 10/00

(52) U.S. Cl. 705/8; 705/14.4

(57) ABSTRACT

The disclosure describes systems and methods for Integrated advertising management. An Integrated Ad Manager (IAM) loaded and stored within a media player on a user computer receives information from at least one publisher for use in managing advertisements. The information relates to available advertisement inventory of the at least one publisher of advertisements. The IAM facilitates determining advertisements to be served in connection with media content being rendered by the media player based at least in part on the received information. The IAM facilitates serving of advertisements, at least in part based on the determined advertisements, for visible display on a user computer in association with the media content being rendered. An ad management system serves or facilitates serving of the advertisements based at least in part on the information received from the IAM.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

As the number of people communicating over a publicly accessible communication network, such as the Internet, continues to grow, the use, availability and distribution of media content via the Internet, such as video and audio media files and advertisements, grows as well. The popularity of delivering and experiencing media content via the Internet continues to grow because the Internet provides for both immediacy of the media and interactivity of the media. Media content and advertisements can provide a rich interactive user experience from a network connected device. Delivering media content and advertisements via the Internet is quickly gaining adoption as a mechanism for reaching consumers for purposes of marketing and monetizing media assets.

Some of the challenges with marketing and monetizing media assets over the Internet, such as broadband video, are due to the ubiquitous and on-demand nature of the medium. Web-sites provide a wide range of video content varying in content type, duration and quality. Many web-sites make video content accessible at the request or upon demand of the user and/or provide the users with accompanying advertisements upon viewing the media content. Video media is also available to users from a wide range of network connected devices, such as cell phones and other mobile devices.

### SUMMARY

Among other things, the present disclosure solves problems and ineffectiveness in relation to costly unsold advertisement (ad) inventory. For example, some embodiments of the present disclosure provide systems and methods for reducing and eliminating unsold ad inventory and maximizes ad revenue potential for online video publishers. Online video publishers of advertisements are provided the ability to allocate or otherwise influence their ad inventory amongst multiple third party ad networks or online publishing partners from a single, user-friendly interface (UI).

One aspect of the disclosure is a method for managing advertisements, including an Integrated Ad Manager (IAM) within a media player that receives information from at least one publisher for use in managing advertisements. The information relates to available advertisement inventory of the at least one publisher. The IAM facilitates determining advertisements to be served in connection with media content being rendered by the media player based at least in part on the received information. The IAM facilitates serving of advertisements, at least in part based on the determined advertisements, for visible display in association with the media content.

Another aspect of the disclosure is a computer-readable medium tangibly encoded with instructions for performing a method for managing advertisements, including an Integrated Ad Manager (IAM) within a media player that receives information from at least one publisher for use in managing advertisements. The information relates to available advertisement inventory of the at least one publisher. The IAM facilitates determining advertisements to be served in connection with media content being rendered by the media player based at least in part on the received information. The IAM facilitates serving of advertisements, at least in part based on the determined advertisements, for visible display in association with the media content.

Yet another aspect of the disclosure is a system for managing advertisements, including a plurality of processors and a receiving module implemented on one of the plurality of the processors for receiving information relating to available advertising inventory of at least one publisher for use in managing advertisements. A determining module implemented on one of the plurality of the processors for facilitating determining the advertisements to be served in connection with media content being rendered by the media player based at least in part on the received information. A serving engine implemented on one of the plurality of the processors for facilitating serving of advertisements for visible display on a user interface in corresponding to the media content based in part on the determined advertisements from the determination module.

In one aspect, an ad management system facilitates downloading of an Integrated Ad Manager to be stored within a media player stored on a user computer. The ad management system communicates first information to the Integrated Ad Manager for facilitating determining ads to be served in connection with media content to be rendered on the user computer by the media player, the first information having been transmitted to the Integrated Ad Manager based at least in part on second information, the second information for use in managing ads, and the second information having been send to the Integrated Ad Manager from at least one publisher or publisher network. The ad management system serves or facilitates serving of ads based at least in part on the first information.

These and various other features as well as advantages will be apparent from a reading of the following detailed description and a review of the associated drawings. Additional features are set forth in the description that follows and, in part, will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the disclosure as claimed.

### BRIEF DESCRIPTION OF THE DRAWINGS

The following drawing figures, which form a part of this application, are illustrative of embodiments systems and methods described below and are not meant to limit the scope of the disclosure in any manner, which scope shall be based on the claims appended hereto.

FIG. 1 is a schematic illustration of an embodiment of an architecture for facilitating an interaction between clients and publishers.

FIG. 2 a schematic illustration of an embodiment of an architecture for facilitating an interaction between a media player on a client's user machine and a publisher.

FIG. 3 is a block diagram of an embodiment of an implementation of a media player on a client's user device.

FIG. 4 is a block diagram of an embodiment of an Integrated Ad Manager (IAM) as an advertising platform.

FIG. 5 a schematic illustration of an embodiment of an architecture for facilitating an interaction between a media player on a client's user machine and 3^{rd} parties.

FIG. 6A-6B are flowcharts illustrating embodiments of steps for managing and serving advertisements.

FIG. 7 is an embodiment of the system components of the Integrated Ad Manager (IAM).

### DETAILED DESCRIPTION

Reference will now be made in detail to embodiments of advertisement management systems and methods, examples of which are illustrated in the accompanying drawings. Certain illustrative embodiments of the present disclosure are described below. It is, however, expressly noted that the present disclosure is not limited to these embodiments, but rather the intention is that additions and modifications to what is expressly described herein also are included within the scope of the disclosure. Moreover, it is to be understood that the features of the various embodiments described herein are not mutually exclusive and can exist in various combinations and permutations, even if such combinations or permutations are not expressly made herein, without departing from the spirit and scope of the disclosure.

The illustrative embodiments of the media delivery platform described herein provide a solution for creating, distributing and managing intelligent and cost-effective delivery of video, audio and broadband media content over a network, such as the Internet, to a user interface, such as a desktop, mobile computing, and network connected devices. In some embodiments, the media delivery platform provides an Internet Protocol or IP TV platform to create, distribute and manage Internet based or broadband based video, such as direct-to-consumer broadband video channels. The media platform provides Internet-based video publishing, syndication and community building functionality and services. The media delivery platform also provides content and advertising network integration in support of monetizing media assets via delivery of Internet based advertisement in conjunction with video.

In some embodiments and as will be discussed in greater detail below, the media delivery platform includes an ad delivery platform, or ad platform, to provide functionality for the delivery of on-demand video advertisement. The ad platform, herein referred to as an Integrated Ad Manager (IAM) provides a solution for the delivery of ads overlaid on video streams by controlling ad insertion frequency and format of the ads based on allocation information relating to an advertising publisher's advertisement inventory. Other ad based information relates to a user profile, user behavior history, topic of the stream to be delivered, duration of the video or ad, and/or the popularity rating of the video or ad. The IAM can also provide the publishers of advertisements usage reports identifying delivery of ads. The IAM can provide input to ad inventory management as a forecasting tool for determining the available inventory of ad placement based on data collected over a period of time regarding the delivery of ads and advertisement requests for a particular network to be used for the delivery of a desired ad.

For the purposes of this disclosure, a computing device (also referred to herein as a “computer”) includes at least one processor and memory for storing and executing program code, data and software. Computing devices may be provided with operating systems that allow the execution of software applications in order to manipulate data. Personal computers, PDAs, wireless devices, cell phones, internet appliances, media players, home theater systems, and media centers are several non-limiting examples of computing devices. The user interface that is used to display the media content and advertisements is implemented on a computing device and will be understood by one of skill in the art.

For the purposes of this disclosure, a server comprises software and/or hardware running on one or more computing devices which receives information requests from other servers, user computers, or other computing devices, and responds to such requests. A number of program modules and data files may be stored on a computer readable medium of the server. They may include an operating system suitable for controlling the operation of a networked server computer, such as the WINDOWS VISTA, WINDOWS XP, or WINDOWS 2003 operating systems published by Microsoft Corporation of Redmond, Wash., the Ubuntu operating system distributed by Canonical Ldt. of Douglas, Isle of Mann.

For the purposes of this disclosure a computer readable medium stores computer data in machine readable form. By way of example, and not limitation, a computer readable medium may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology; CD-ROM, DVD, or other optical storage; cassettes, tape, disk, or other magnetic storage devices; or any other medium which can be used to store the desired information and which can be accessed by the computer.

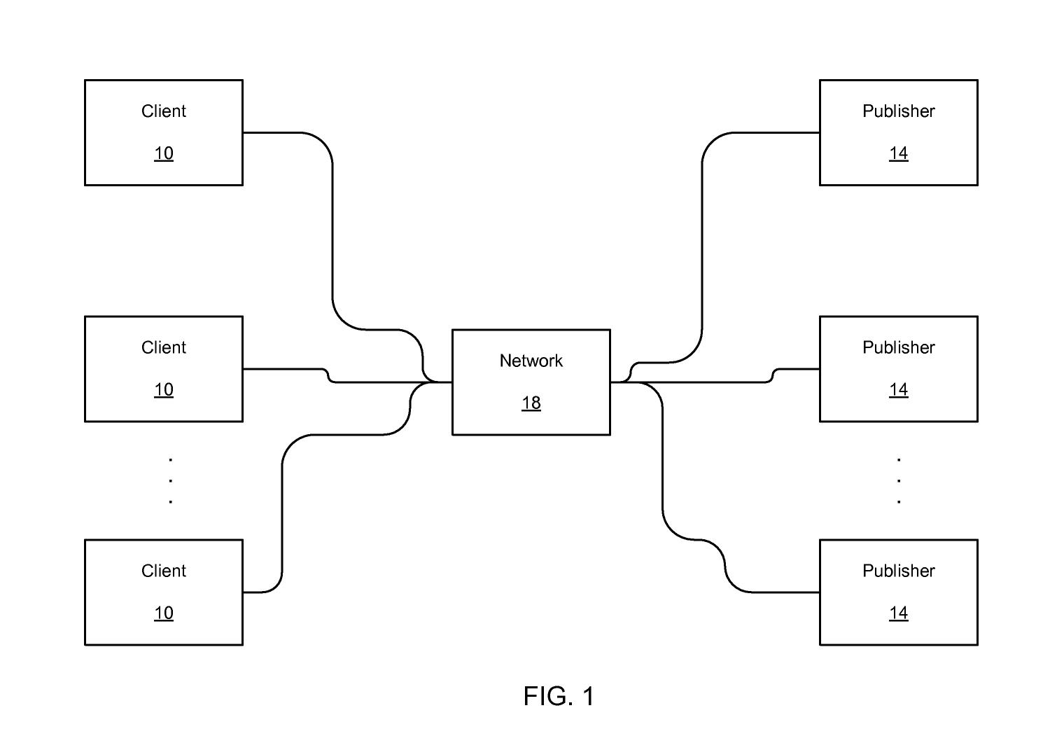

Referring now to FIG. 1, in brief overview, one embodiment of a client-server system in which the present disclosure may be used is depicted. A first computing system (client node) 10 communicates with an advertising publisher 14 over a communications network 18. The communication network 18 includes a server or servers that are capable of interacting using the protocol typical to a computer network. Servers may be provided as a group of server systems logically acting as a single server system referred to herein as a server farm, within the network 18.

The network 18 can be any type and/or form of network and may include any of the following: a point to point network, a broadcast network, a wide area network, a local area network, a telecommunications network, a data communication network, a computer network, an ATM (Asynchronous Transfer Mode) network, a SONET (Synchronous Optical Network) network, a SDH (Synchronous Digital Hierarchy) network, a wireless network and a wireline network. In some embodiments, the network 18 may comprise a wireless link, such as an infrared channel or satellite band. Network 18 topology may be of any such network or network topology as known to those ordinarily skilled in the art capable of supporting the operations described herein.

The client nodes 10 representing the computing devices from which information served from the publisher 14 can be visibly displayed. Information received from the publisher 14 comprises media content and advertisements. The advertisements to be served along with the media content originate from publishers 20 of the ad content. The network 18 can be a local area network (LAN), a metropolitan area network (MAN), a wireless network, a wide area network (WAN) such as the Internet, or any other communication network known in the art.

The client 10 and publisher 14 can connect to the network 18 through a variety of connections including standard telephone lines, LAN or WAN links (e.g., T1, T3, 56 kb, X.25, SNA, DECNET), broadband connections (ISDN, Frame Relay, ATM, Gigabit Ethernet, Ethernet-over-SONET), and wireless connections. Connections can be established using a variety of communication protocols (e.g., TCP/IP, IPX, SPX, NetBIOS, Ethernet, ARCNET, Fiber Distributed Data Interface (FDDI), RS232, IEEE 802.11, IEEE 802.11a, IEEE 802.11b, IEEE 802.11g, and direct asynchronous connections). Other client nodes and publishers (not shown) may also be connected to the network 18.

The client nodes 10 are provided as any device capable of displaying video and otherwise capable of operating in accordance with the protocols disclosed herein, such as personal computers, windows-based terminals, network computers, information appliances, X-devices, workstations, mini computers, personal digital assistants or cell phones. In some embodiments, the publisher 20 of the advertisements may be embodied in private or separate networks from that of other publishers (not shown) or from the client 10 and network 20. The network 18 can be a multi-user server system supporting multiple concurrently active client connections.

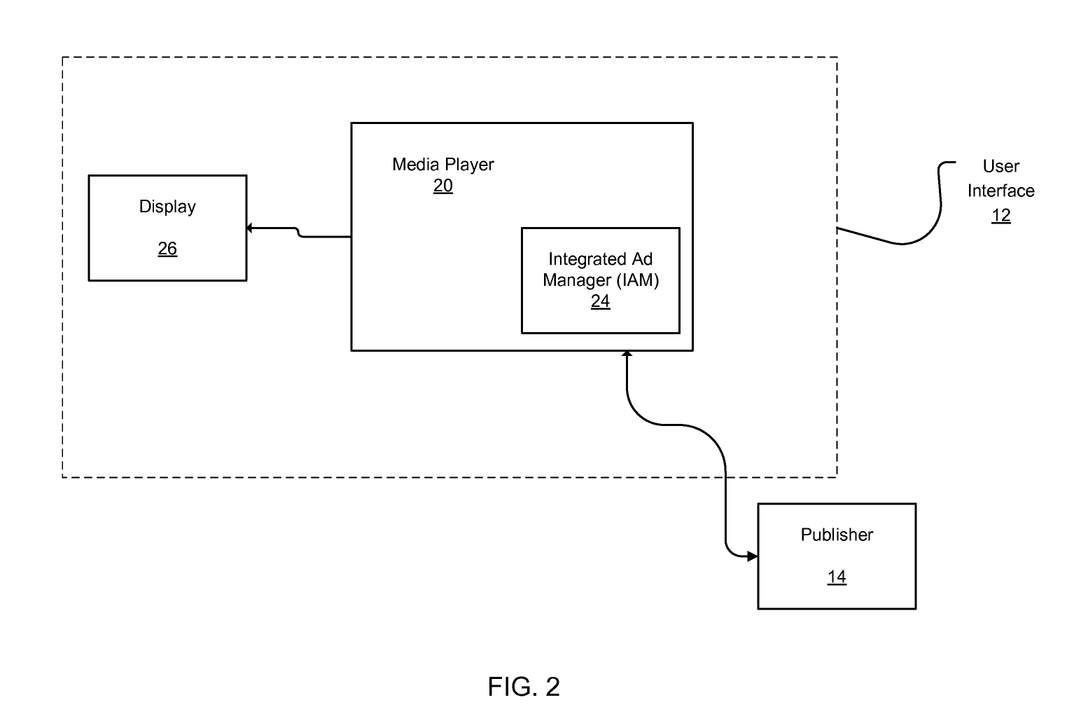

As shown in FIG. 2, a user interface (UI) 12 on a client's user computer device includes a media player 20 and an Integrated Ad Manager (IAM) 24. The client computing device can be any type of computing or mobile device as discussed above and the media player 20 is utilized to render media. The IAM 24 and the media player 20 are incorporated together. The IAM 24 is an API or plug-in that is implemented within or with the media player 20. In some embodiments, the media player 20 and the IAM 24 may be provided as software applications permanently stored on a hard disk drive on the client's computing device. Alternatively, the IAM 24 may be downloaded from a server (or servers) by a client (user).

The IAM 24 can download and store content to be used for display by the media player 20 in the display 26. According to these embodiments, the media player 20 and IAM 24 are implemented within a user interface (UI) 20. Although communicated data may be stored in any form of persistent storage such as tape media, compact disc media, or floppy disk media, the IAM 24 may store data served from a publisher 14 on a hard drive associated with the client computing device. The types of data the correspond to the downloaded data can be any type of advertising information produced from the publishers 14 of advertising information and media, as discussed below. It will be understood that there can be a multitude of publishers 14 communicating with the IAM 24. Also, it will be understood, that the multitude of publishers may be communicating with the IAM 24 from differing networks.

The UI 12 may include an application, program, library, script, service, process, task or any other type and/or form of executable instructions. In some embodiments, the UI 12 can be a browser-based interface. In one embodiment, the UI 12 includes any type and form of Rich Internet Application. In other embodiments, the display 26 displays content from such outlets as web page files, e.g., AJAX, HTML file, Dynamic HTML (DHTML), Flash within HTML, ActiveX or JavaScript via the media player 22. The IAM 24 receives advertising information from the publisher 14 and in some embodiments, advertisers or ad management systems. This information provides functionality for the delivery of advertisement, such as Internet based and video ads, in conjunction with delivery of video media.

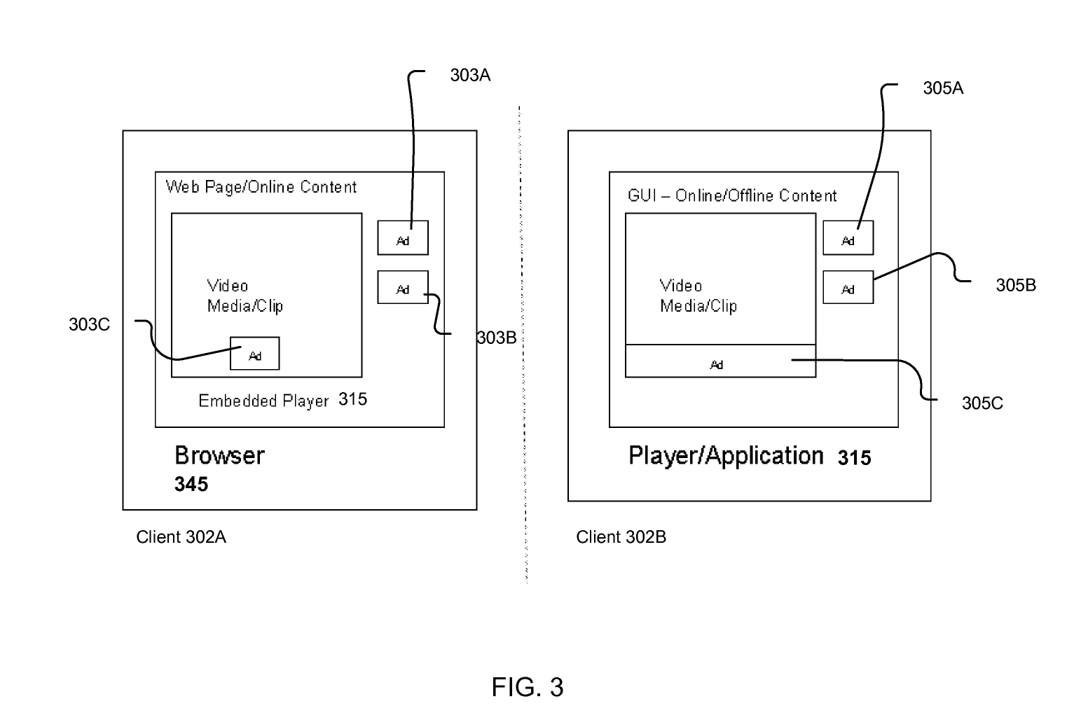

A media player may be implemented on either a web page or a browser of a computer device, as seen in FIG. 3. The IAM is loaded into the media player as a plug-in or similar type of add-in component. In some embodiments, the IAM may be conceptually based in the media player. The IAM may be external to the media player in some embodiments, but remaining in real-time connection with the media player. The IAM can be used to deliver advertisements accompanying media content to a user via a media player. FIG. 3 illustrates some embodiments of a client 302 for receiving delivery of video content and ads are depicted. Alternatively, a client 302A may include a browser 345 for connecting to, communicating with and receiving content via a network 304. The client 302A may connect via the browser 345 to a web site providing a media player 315, such as a media player embedded in online content of a web page. In some embodiments, the client 302A, browser 345 or player 315 may access offline content via memory or storage accessible by client 302A, such as via a cache. In other embodiments, the browser 345 or player 315 provides access to both online and offline content.

The player 315 may access any type and/or form of application, program, service, library, process, or set of executable instructions for accessing content via a network, such as the Internet using uniform resource locators. The player can be implemented via any type and form of graphical user interface, such as a browser Microsoft® Internet Explorer browser and/or Netscape™ browser, or a FireFox browser, or through known media players

In another embodiment, a client 302B may include a media player 315 or application for playing media, such as video, and/or for displaying any type and form of graphical user interfaces. In one embodiment, the player 315 or application provides access to or plays downloaded or offline content. In some embodiment, the player 315 accesses content or receives delivery of content via a network. In one embodiment, the player 315 provides access to both online and offline content.

The media player 315 may include any type and/or form of software, hardware, or combination of software and hardware for experiencing, running, or otherwise playing a media in any form, such as various types and forms of information and data, electronic, digital or otherwise, for conveying information via text, audio, graphics, animation, video and/or interactivity. In some cases, multimedia may also refer to the use of a plurality of media, such as video, audio and data.

In some embodiments, the media player 315 comprises an application, program, library, script, service, process, task or any other type and/or form of executable instructions. In one embodiment, the media player 315 comprises one of the following: the Windows Media Player manufactured by the Microsoft Corporation of Redmond, Wash., iTunes or QuickTime manufactured by Apple Computer, Inc. of Cupertino, Calif., RealPlayer® manufactured by RealNetworks, Inc. of Seattle, Wash., or Macromedia Flash Player manufactured by Adobe Systems Incorporated of San Jose, Calif. In other embodiments, the media player 315 includes any custom, proprietary, open source, shareware, freeware or any other type of application, program or executable instructions capable of playing media, either for a specific purpose or otherwise for an general or desired purposes. Additionally, the media player 315 may include any type and/or form of user interface, graphical or otherwise, for accessing, controlling, managing, or otherwise providing input and/or receiving output regarding media and/or the playing of media. In some embodiments, the advertisements 303(A-C) and/or 303(A-C) may be visually displayed before, after or during the media content display. In some embodiments, only some, if not one of, the advertisements 303(A-C) and/or 303(A-C) may be displayed along with the media content being displayed in the media player 315 via pre/post video ad rolls and interactive overlays.

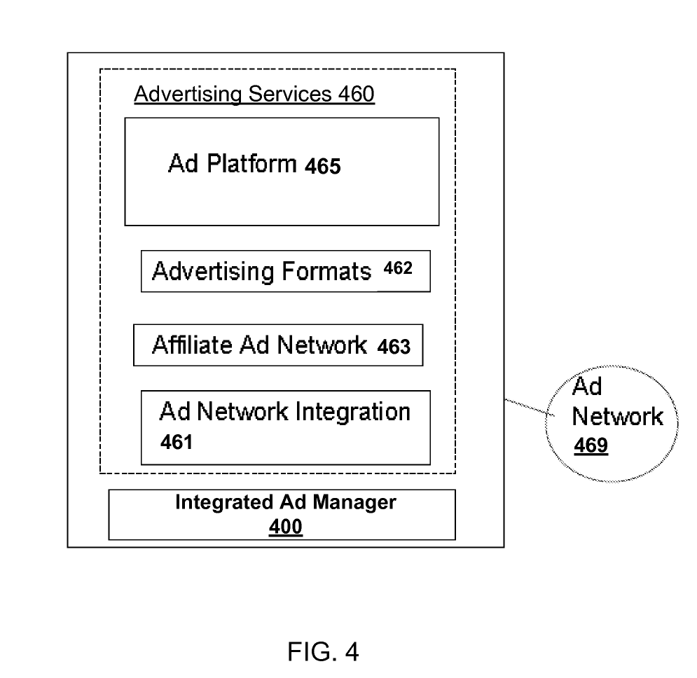

Referring now to FIG. 4, an embodiment of the advertising services 460 of the IAM 400 that is incorporated within a media player is depicted. The advertising service 460 provides functionality and support to monetize media assets via use of advertisement, such as online, video, or Internet based advertisements. The advertising services 460 include at least the following functionality, services, operations, logic or components: 1) ad network integration 461, 2) advertising formats 462, 3) affiliate ad network support 463, and an ad server platform 465.

The advertising services 460 include an ad network integration component 461 to interface, communicate and coordinate with advertisement network providers 469. An ad network 469 comprises any type and form of aggregator or broker of advertising inventory for many web sites. In some embodiments, an ad network comprising advertising publishers 469 is considered a sales representative for the web sites within a network. In one embodiment, the ad network 469 includes any of the advertisement services from any type of ad or product provider. The ad network integration components 461 may include any type and form of application programming interface, programming language, and tools and use any type and form of one or more communication, networking or application layer protocols to interface or communicate with an ad network 469.

In some embodiments, the ad network integration 461 provides interfaces and communicates with multiple ad networks, concurrently, simultaneously, subsequently or otherwise. The advertising services 460 includes support for affiliate ad networks by providing functionality 463 to allow the use of multiple ad networks 461 from a single account. The advertising services 460 may integrate or communicate with content and advertisement or ad management providers, applications or systems, for example those provided by Lightningcast, Inc. of Washington, DC, which is owned by AOL, LLC of Dulles, Va., or by DoubleClick, Inc. of New York, N.Y. In this manner and in some embodiments, any affiliate or business partner can use an affiliate determined or specified ad network 461 to manage and sell advertisement inventory.

The advertising services 460 provide an interface and configuration mechanism to design, configure, or otherwise create and use any type and form of format for advertising. An ad may comprise any visual or graphical information, representation or display. An ad may include video, audio, data, text, graphics, pictures, HTML, DHTML, Flash or web page content, applets, programming language, scripts, uniform resource locators, or any combination thereof. The ad format may include any type and form of video effects or overlays such as a bug style ad format or video curtain type of ad format. As will be described in further detail below, an ad format may specify the type, location, and duration of an ad. For example, an ad format may specify the ad as a pre or post-roll video. In some embodiments, the advertising formats 462 includes any of the formats supported, specified or identified by the Interactive Advertising Bureau (IAB) and/or any of the IAN standards or guidelines.

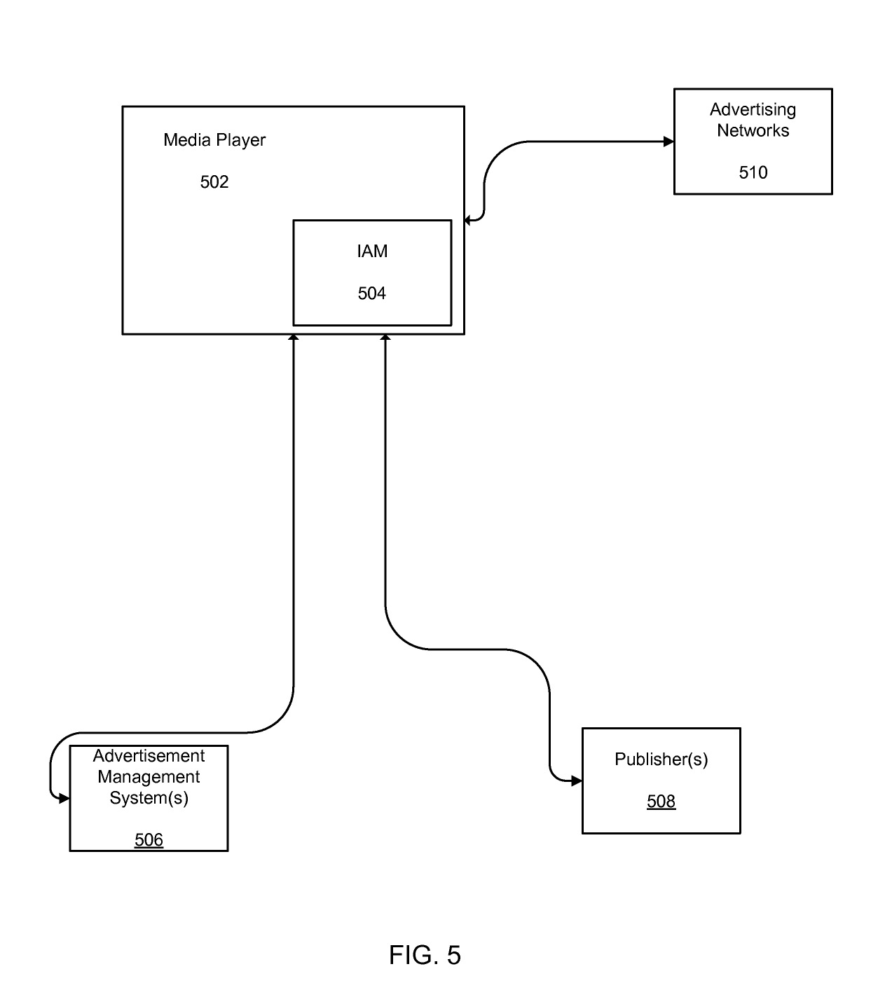

As seen in FIG. 5, online video publishers have the ability to allocate their ad inventory via pre/post video ad rolls and interactive overlays amongst multiple 3^{rd} party ad networks or online publishing partners from a single user device. The IAM 504 having been loaded into the media player 502 interacts with at least one of advertisement publishers 508 or publisher network, advertisement management systems 506 and one or more advertisement networks 510. As discussed above, the IAM 504 uploaded into the media player 502 as an API, plug-in, add-in or as any other downloadable components. The IAM 504 allows the media player 502 to communicate with the publishers 508, ad management systems 506 and ad networks 510 directly and in real-time (or dynamically). The player 502 provides a vehicle for the advertisements to be rendered with video content. The publishers 508 can allocate unsold advertisement inventory and transmit information corresponding to the ad inventory to the IAM 504. The information transmitted relates to available ad inventory for each publisher 508.

According to some embodiments, publishers 508 can easily determine the percentages of ad requests that are directed to a particular ad network 510, and transmit that information to the IAM 504 which is embedded within the media player 502. For example, an online video publisher may choose to allocate 50% of their inventory to an ad network such as Yahoo!, while the other 50% can be allocated and sold by their own internal sales force and served using the publisher's ad management system 506 like DoubleClick DART or Atlas AdManager. Additionally, publishers 508 set inventory allocations based on the type of video content selected and played by the end consumer on the media player 502. The publishers 508 may also increase and/or decrease inventory allocations dynamically. Allocations can be set based on the title of the video clip, the playlist that contains the video clip, the genre or category classification of the video clip as well as the licensor of the video clip. According to some embodiments, allocations can be set from any available metadata provided by the video player and video content being played. Also, inventory allocations can also be set based on a specific user, identified by a user cookie, such that ads served during that user's session are being served from a specific ad network. In some embodiments, each of the publishers in contact with the IAM 504 within a single media player 502 may be on a different advertising network 510. In accordance with the received information relating to ad inventory of each publisher 508, the IAM 504 may contact other ad networks 510 for additional ad space corresponding to video content and advertisements that are queued to be rendered, or are logged within a sequence or playlist compiled by the IAM 504.

After the IAM 504 receives the inventory information for a publisher 508, it transmits the information to an advertisement management system 506. The advertisement management system 506 compiles the information received relating to the ad inventory of a publisher 508, and subsequently serves an advertisement to the media player 506 for rendering along with video content. According to some embodiments, the information transmitted to the ad management system 506 may comprise a playlist or sequence of advertisements compiled by the IAM 504 from information received from one or more publishers 508. Accordingly, the advertisement management system may use the information received from the IAM 504 and separate information collected or gathered for the advertisements. This separate information can then be served along with the advertisements to the media player 502, thereby influencing rendering of the video content and advertisements according to the length, positioning, size and/or other parameters with respect to the served advertisement(s).

In some embodiments, the IAM 504 may also be in communication with differing advertising networks 510. The ad networks 510 can send additional information about the publishers 508 present in their network and/or information corresponding to a particular advertisement or ad. The IAM 504 manages advertisements served from the ad management system 506, the publishers 508 and/or the differing ad networks 510 in real-time. The real-time management allows for planning and forecasting future advertisements to be rendered by the media player 502. As discussed above, videos and advertisements can be organized in the media player 502 by the IAM 504 in the form of a playlist or sequence of media. In some alternative embodiments, specific publishers 508 may target a specific type of user, demographic, genre, or other category for certain advertisements. The IAM 504 can recognize this information, and according the viewing audience, can dynamically render the appropriate advertisement with a corresponding video. It should be understood, that although the examples and description above all relate to video content, one of ordinary skill in the art will understand that all types of media content can be accompanying by advertisements in varying manners; therefore, the IAM 504 may be implemented in different types of media rendering modules or components.

According to some embodiments, the IAM 504 enables the media player 502 to keep track of real-time content corresponding to advertisements. The IAM 504 can determine when and where is the best time to display the advertisement that accompanies the video content. Furthermore, the IAM 504, based on received information from the publishers 508, ad management systems 506 and the ad networks 510, may assist or entirely decide whether to add or decrease inventory based on the available content to be rendered in a playlist. The IAM 504 can contact additional publishers and/or ad networks, and/or re-contact a publisher for additional advertisements or ad inventory information in real-time if the IAM 504 determines that additional or empty ad space that is available.

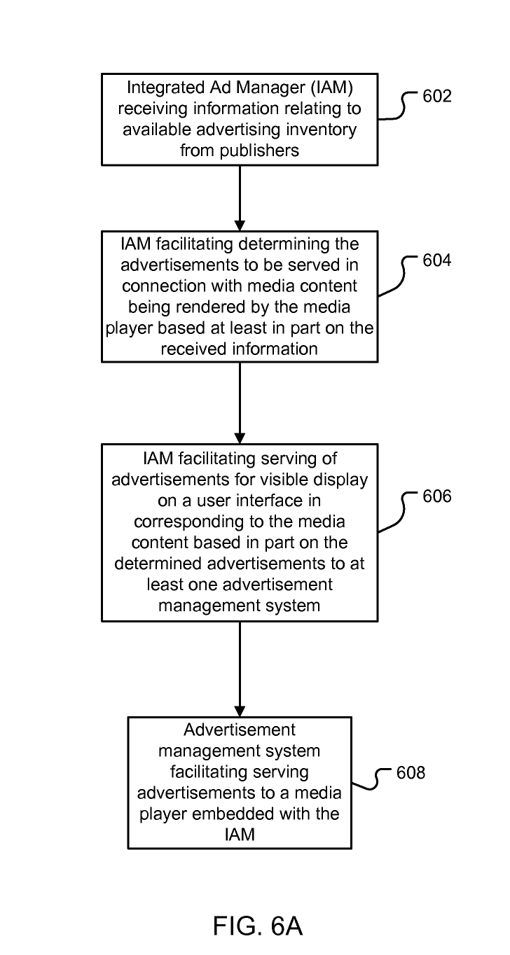

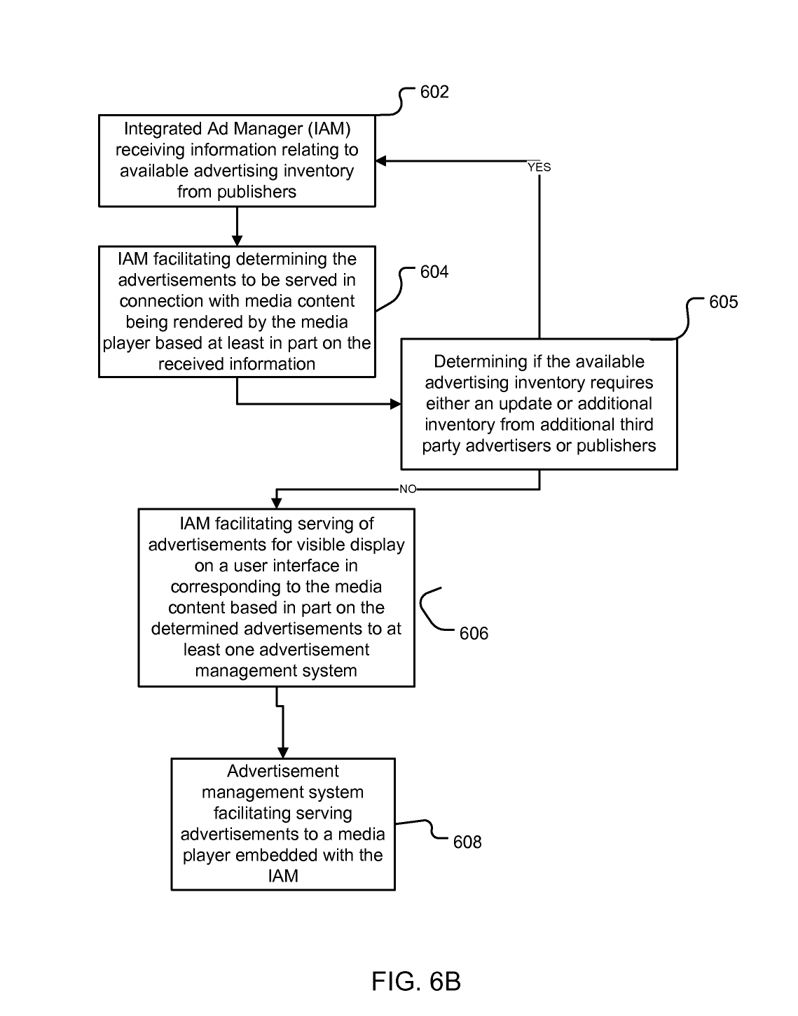

A publisher has the ability to allocate advertisements based on ad inventory amongst multiple 3^{rd} party ad networks or online publishing partners determined by a Integrated Ad Manager (IAM) loaded in a media player, as discussed in FIG. 6A. Initially, the IAM communicates with a publisher in order to receive information relating to the publisher's available inventory of advertisements for a particular ad network, step 602. In some embodiments, the IAM will ping the publisher or publishers for information. In some alternative embodiments, the IAM's real-time communication with the publisher allows the publisher to communicate in real-time with updated ad inventory allocation information. Once the IAM has received the inventory allocation information for a publisher's advertisements, the IAM compiles this information and determines which advertisements are to be served in connection with media content being rendered or queued up for rendering by a media player, step 604. The IAM then transmits this information to at least one advertisement management system, step 606. The advertisement management system receives this information and in real-time serves the ad or ads back to the media player where the IAM is imbedded, step 608. The advertisement management system serves the ad or ads based at least in part on the determined advertisements by the IAM in view of the information received from the publisher or publishers. In some alternative embodiments, the advertisement management system will utilize additional information either collected by the ad management system itself about the advertisements or publisher(s), or collected by the IAM from the ad network or networks.

In some embodiments, as discussed above, there will be empty or additional ad space or lack of ad inventory that needs to be filled, therefore the IAM will contact other publishers or ad networks, or re-communicate through an existing publisher relationship, as discussed in FIG. 6B. As discussed in FIG. 6A, the IAM communicates with a publisher in order to receive information relating to the publisher's available inventory of advertisements for a particular ad network, step 602. Once the IAM has received the inventory allocation information for a publisher's advertisements, the IAM compiles this information and determines which advertisements are to be served in connection with media content being rendered or queued up for rendering by a media player, step 604. Once the IAM has determined the amount of ad inventory collected from at least one publisher to accompany media content upon rendering, the IAM may contact any one of another publisher(s), an existing publisher(s) or another ad network to increase ad inventory. If the inventory is below a threshold that indicates a minimal amount of advertisements to accompany a playlist of media files, the IAM will contact another 3^{rd} party for additional ad inventory, step 605. Once this occurs, the process will proceed back to step 602, where the IAM receives information relating to available ad inventory for a particular publisher or ad network. If the determined amount of ad space is satisfactory in view of the media content and allotment of ads to accompany the media content, the process proceeds to step 606. The IAM then transmits this information to at least one advertisement management system, step 606. The advertisement management system receives this information and in real-time serves the ad or ads back to the media player where the IAM is imbedded, step 608. The advertisement management system serves the ad or ads based at least in part on the determined advertisements by the IAM in view of the information received from the publisher or publishers. In some alternative embodiments, the advertisement management system will utilize additional information either collected by the ad management system itself about the advertisements or publisher(s), or collected by the IAM from the ad network or networks.

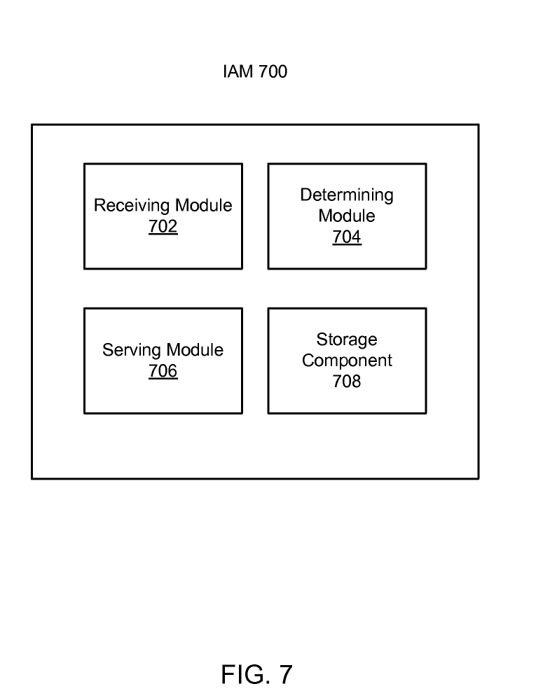

As discussed above in relation to FIGS. 4-6B, the IAM interacts with publishers, ad networks, and ad management systems with at least the purpose of serving advertisements along with media content to a media player based on available advertisement inventory, as shown in FIG. 7. An Integrated Advertisement Manager 700 includes a receiving module 702, determination module 704, serving module 706 and a storage component 708. The receiving module 702 within the IAM 700 receives information from at least one publisher for use in managing advertisements, as discussed above. The information relates to an available advertisement inventory of the at least one publisher. The determination module 704 within the IAM 700 facilitates a determination of advertisements to be served in connection with the media content being rendered by the media player. The determination engine bases its decision on at least the received information from the receiving module, as discussed above. The serving module 706 of the IAM facilitates serving of the determined advertisements based upon information produced from the determination module 704 for visible display through the media player on a user's display. The serving module transmits the information to an advertisement management system indicating which advertisements are to be served to the media player that the IAM is loaded. The IAM 700 also maintains a storage component 708. The storage component can store the information produced from the receiving engine 702, determination engine 704, and/or serving engine 706. The storage component 708 can also store information about the media player, media content to be rendered, the user preferences about media or advertisements and/or a user profile of the user viewing the media content and advertisements. The storage component 708 can be a database or any other type of device or component known within the art for storing real-time data. The storage component 708 can be periodically updated depending on the frequency of updated data. In some embodiments, the storage component 708 is updated each time new information is received or transmitted in the IAM 700. Alternatively, the storage component 708 may be external to the IAM 700. In these alternative embodiments, the storage component may be located on a network, locally on a users computer or within the media player.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure. Numerous other changes may be made that will readily suggest themselves to those skilled in the art and which are encompassed in the spirit of the disclosure(s) disclosed.

What is claimed is:

1. A method for managing advertisements, comprising:
an Integrated Ad Manager (IAM) receiving information from at least one publisher for use in managing advertisements, the information relating to available advertisement inventory of the at least one publisher, the IAM being within a media player;
the IAM facilitating determining the advertisements to be served in connection with media content being rendered by the media player based at least in part on the received information; and
the IAM facilitating serving of advertisements, at least in part based on the determined advertisements, for visible display in association with the media content.

2. The method of claim 1, wherein the IAM further comprises providing the at least one publisher the ability to allocate a predetermined amount of the advertisement inventory for a network.

3. The method of claim 1, wherein facilitating serving comprising:
communicating with an advertisement system for serving of the advertisements based on the received information.

4. The method of claim 1, wherein the available advertisement inventory is determined by the at least one publisher.

5. The method of claim 1, wherein the facilitating determining the advertisements further comprising:
scheduling the available advertisements for rendering with the media content.

6. The method of claim 1, wherein the IAM determines the advertisements to be served based on available metadata provided by the media player.

7. The method of claim 6, wherein the IAM determines the advertisements to be served based on a title of the media content.

8. The method of claim 6, wherein the IAM determines the advertisements to be served based on the media content being rendered.

9. The method of claim 1, wherein the IAM determines the advertisements to be served based on ad requests for each network.

10. The method of claim 1, wherein the determining of advertisements to be served occurs dynamically in real-time.

11. The method of claim 1, wherein the at least one publisher being a multitude of publishers each having an available inventory of advertisements.

12. The method of claim 14, wherein the multitude of publishers being from different networks.

13. A method for managing advertisements, comprising:
an ad management system facilitating downloading of an Integrated Ad Manager (IAM) to be stored within a media player on a user computer;
the ad management system communicating first information with the IAM for facilitating determining advertisements to be served in connection with media content to be rendered on the user computer by the media player, the first information being based at least in part on second information, the second information for use in managing advertisements and having been sent to the IAM from at least one publisher; and
the ad management system serving or facilitating serving of the advertisements based at least in part on the second information.

14. A computer-readable medium tangibly encoding instructions for performing a method, comprising:
an Integrated Ad Manager (IAM) receiving information from at least one publisher for use in managing advertisements, the information relating to available advertisement inventory of the at least one publisher, the IAM being within a media player;
the IAM facilitating determining the advertisements to be served in connection with media content being rendered by the media player based at least in part on the received information; and
the IAM facilitating serving of advertisements, at least in part based on the determined advertisements, for visible display in association with the media content.

15. The computer-readable medium of claim 14, wherein the IAM further comprises providing the at least one publisher the ability to allocate a predetermined amount of the advertisement inventory for a network.

16. The computer-readable medium of claim 14, wherein facilitating serving comprising:
communicating with an advertisement system for serving of the advertisements based on the received information.

17. The computer-readable medium of claim 14, wherein the available advertisement inventory is determined by the at least one publisher.

18. The computer-readable medium of claim 14, wherein the facilitating determining the advertisements further comprising:
scheduling the available advertisements for rendering with the media content.

19. The computer-readable medium of claim 14, wherein the IAM determines the advertisements to be served based on available metadata provided by the media player.

20. The computer-readable medium of claim 14, wherein the IAM determines the advertisements to be served based on ad requests for each network.

21. The computer-readable medium of claim 14, wherein the determining of advertisements to be served occurs dynamically in real-time.

22. The computer-readable medium of claim 14, wherein the at least one publisher being a multitude of publishers each having an available inventory of advertisements.

23. The computer-readable medium of claim 15, wherein the multitude of publishers being from different networks.

24. A system comprising:
a plurality of processors:
a receiving module implemented on one of the plurality of said processors for receiving information relating to available advertising inventory of at least one publisher for use in managing advertisements;
a determining module implemented on one of the plurality of said processors for facilitating determining the advertisements to be served in connection with media content being rendered by the media player based at least in part on the received information; and
a serving engine implemented on one of the plurality of said processors for facilitating serving of advertisements for visible display on a user interface in corresponding to the media content based in part on the determined advertisements from the determination module.

25. The system of claim 24 further comprising:
a storage component for storing the information produced from the receiving engine, determination engine, and/or serving engine.

26. The system of claim 24, wherein the determination engine determines the advertisements to be served based on ad requests for each network in real-time.
